(19) United States
(12) Patent Application Publication
(10) Pub. No.: US 2009/0063308 A1
(43) Pub. Date: Mar. 5, 2009

(54) METHODS AND SYSTEMS FOR ENCOURAGING REDUCTIONS IN POLLUTANT GAS PRODUCTION

(76) Inventor: David E. Cumming, Park City, UT (US)

Correspondence Address: SNELL & WILMER L.L.P. (Main), 400 EAST VAN BUREN, ONE ARIZONA CENTER, PHOENIX, AZ, 85004-2202, US

(21) Appl. No.: 12/202,014

(22) Filed: Aug. 29, 2008

Related U.S. Application Data
(60) Provisional application No. 60/969,456, filed on Aug. 31, 2007.

(51) Int. Cl. G06Q 10/00; G06Q 50/00

(52) U.S. Cl. 705/28; 705/400

(57) ABSTRACT

The methods and systems described herein encourage reductions in the production of pollutant gases by converting the individual's local efforts into a demonstration of the individual's global impact. The systems and methods enable an individual to establish a network of associated individuals. The efforts of the individuals within the network are then associated in a way that enables the individuals to see the results of their own efforts and the results of others they have influenced. Individuals in the network may be associated in a hierarchical-type structure, similar to a family-tree type structure, and some or all of the carbon savings of descendants may be attributed to the parent, grandparent, etc. Any of a variety of computational methods may be applied to reward an individual for efforts to encourage others to reduce the production of pollutant gases.

### CROSS REFERENCE TO RELATED APPLICATIONS

This application claims priority to U.S. Provisional Application No. 60/969,456 entitled “Methods and Systems for Encouraging Reductions in Pollutant Gas Production,” filed Aug. 31, 2007, which is incorporated by reference herein in its entirety.

### FIELD OF THE INVENTION

This disclosure generally relates to interactive networks, namely, systems and methods that encourage the reduction of pollutant gases.

### BACKGROUND

For many years now, scientists, politicians, and concerned citizens have been discussing issues related to global warming and climate change. Much of the discussion includes studies and reports that suggest the observed changing climate may be connected to human activities. A variety of human activities produce emissions that may have an impact on our environment. Among the many emissions that are harmful to the environment, it is currently believed by many that emissions that include carbon, such as carbon dioxide, carbon monoxide, and more complicated carbon-containing emissions, contribute to global warming. In a simplified manner of explaining the impact of these carbonic emissions, the impact of the carbonic gases are often referred to as creating a “greenhouse” in the upper atmosphere that traps heat in the earth's atmosphere that would otherwise have been allowed to escape the atmosphere into space. Accordingly, carbon-containing gaseous emissions are often referred to as greenhouse gases.

Carbon-containing emissions are the most common greenhouse gases and are most frequently addressed by the media. However, other gases may also contribute to the observed global warming. Moreover, the production of various gases may have a negative impact on the world's environment in ways other than, or in addition to, the problems of global warming. Accordingly, while carbon-containing gases are the archetype for harmful or unwanted emissions, there are a plentitude of pollutant gases that could impact the world.

While many people have heard of the reports and desire to improve the environment, and while public opinion, public policy, and even some legislation has now focused on the need to at least slow the rate of increase in the global production of these pollutant gases, significant progress has yet to be observed. At the present time, few if any governments are aggressively moving to address the apparent need to reduce global greenhouse gas production. Additionally, few large corporations, especially few of those that are historically the largest greenhouse gas producers, have adopted policies, technologies, or even positions that would move them and the world to produce less greenhouse gas. Nevertheless, environmentally friendly programs and companies are gaining a foothold in society. Some of these environmentally friendly programs are even offered by some of the companies that were previously among the highest producers of greenhouse gases.

As one example of such an environmentally friendly program, many utility companies, such as electric companies, now offer consumers a “green” program. These green programs from electric companies come in a number of names and styles, but generally include allowing the consumer to volunteer to receive some portion of their total electricity needs from an environmentally friendly source. Different utility companies offer to draw electricity from different types of sources, such as wind, hydro, nuclear, etc, that are more environmentally friendly than conventional methods of electricity generation, at least with respect to the production of greenhouse or other pollutant gases. Unfortunately, most of these green programs require the consumer to be willing to pay more for that portion of their electricity that comes from an environmentally friendly source. While consumers utilizing such a green program from their utility may feel or receive some degree of satisfaction in knowing that they are making a difference, that difference and/or the satisfaction derived therefrom, often seems quite small in light of the additional costs of these green programs, especially in light of the many other economic pressures on the average family.

Other companies offer green certificates or other forms of similar programs where an individual or entity can pay a certain monetary amount for a certificate or other indicator that the company has done a certain task that will benefit the environment in return for the money. One company for example, will commit to plant a certain number of trees in return for a specified dollar amount, or to buy and/or protect forested land. Generally these programs include something to tell the consumer/participant that their contribution, or payment, conserved a certain amount of carbon as a measure of the good that their contribution has made to the environment. Some companies that follow this model offer “green credits” or “carbon credits” and encourage potential consumers to “off-set” their carbon footprint. These carbon off-set programs are particularly good for individuals that reside in areas where an actual reduction in carbon emissions is not possible or feasible or for individuals that do not have the ability, for whatever reason, to actually reduce their greenhouse gas production rates. However, here again, the costs of these carbon off-sets, carbon credits, or green certificates are yet another burden on the economics of individuals and companies.

Another problem all too common in the efforts of concerned citizens to address the problem of global warming and other problems caused by gaseous emissions is maintaining the interest and commitment of individuals and entities long term. It is common for individuals to be inspired to conserve, or to buy a carbon credit, or to participate in an electric provider's green power program for a period of time after a motivating experience, such as viewing a documentary or a news report that explains the impact of the pollutant gases. However, it is also common for those individuals to reverse course after a period of time when the urgency or significance of the motivating experience has worn off. It is also common to hear of individuals desisting in their efforts due to a feeling that their efforts are not significant. For example, an individual's best efforts to reduce greenhouse gas production attributable to that individual might result in a substantially decrease for that individual. However, even if an individual incurs great expense and exerts great effort to reduce its greenhouse gas production by half, the impact on the global greenhouse gas production will seem minimal at best. In light of the relatively minimal impact of the individual, it is understandable that the motivation would decrease, especially when faced with the increased costs of the efforts to produce less greenhouse gases.

While most people are motivated to some degree by the economics of money, there are not funds available to pay for the world's efforts to reduce pollutant gas production, or at least the funds have not yet been identified and dedicated for such an effort. Accordingly, other means must be found to continually motivate individuals and entities to conserve and to reduce their own production of greenhouse gases.

### BRIEF SUMMARY

For purposes of this summary, the methods and systems described herein may be understood to encourage alteration of any desired behavior, illustratively, for example, by encouraging reductions in the production of pollutant gases. While the way in which the methods and systems can advantageously be used to do so will be described herein, in general, they do so by converting the individual's local efforts into a demonstration of the individual's global or collective impact. As used herein, these efforts to reduce the production of pollutant gases may be referred to in a number of ways. For example, reduce pollutants, reduce greenhouse gases, reduce emissions, etc, may all be used to refer to the efforts, whether individual, local, collective or global, to reduce pollutants. In one aspect of the present disclosure, the systems and methods enable an individual to establish a network of associated individuals. The efforts of the individuals within the network are then associated in a way that enables the individuals to realize the results of their own efforts as well as the results of others they have influenced. In one implementation, individuals in the network may be associated in a hierarchical-type structure, similar to a family-tree type structure, and some or all of the carbon savings of descendants may be attributed to the parent, grandparent, etc. Any of a variety of computational methods may be applied to reward an individual for efforts to encourage others to save carbon.

Additionally or alternatively, in some implementations of the present disclosure, the systems and methods described herein may encourage an individual to expand its impact through inviting others to join the effort to reduce emissions. The individuals participating in the systems and methods of the present disclosure may be encouraged to invite others by rewarding the inviting participants for the participation of the invited persons.

These and other features and advantages of the present disclosure will become more fully apparent from the following description, or may be learned by the practice of the present systems and methods as set forth hereinafter.

### BRIEF DESCRIPTION OF THE SEVERAL VIEWS OF THE DRAWINGS

In order that the manner in which the above-recited and other features and advantages of the present disclosure are obtained will be readily understood, a more particular description of the methods and systems briefly described above will be rendered by reference to the appended drawings. These drawings depict only schematic representations of the methods and exemplary embodiments of some aspects of the system and are not therefore to be considered to limit the scope of the invention.

FIG. 1 is a schematic representation of an embodiment of a network of the present invention;

FIG. 2 is a schematic block diagram representing a method of encouraging individuals to reduce the production of greenhouse gases.

FIG. 3 is a block diagram of an exemplary embodiment of a method of encouraging reduction of pollutant gases;

FIG. 4 is a block diagram of another exemplary embodiment of a method of encouraging individuals to reduce the production of greenhouse gases;

FIG. 5 is an exemplary representation of a user statistics screen which allows potential users to view the pollutant networks of the users;

FIG. 6 is an exemplary representation of a user profile screen illustrating an individual user's profile and the extent of the user's pollutant network;

FIG. 7 is an exemplary representation of an input screen that may be used to register a new user

FIG. 8 is an exemplary representation of an input screen that may be used to collect user information to create a new user profile;

FIG. 9 is an exemplary representation of an input screen that may be used to invite others to become users of the present systems and methods;

FIG. 10 is an exemplary representation of a network selection screen that may be used to allow a user to join another user's pollutant network.

FIG. 11 is an exemplary representation of a user profile input screen following entry of user information and joining a pollutant network.

FIG. 12 is an exemplary representation of a user profile screen displaying the user's profile.

### DETAILED DESCRIPTION OF THE INVENTION

The present invention is described herein and includes various exemplary embodiments in sufficient detail to enable those skilled in the art to practice the invention, and it should be understood that other embodiments may be realized without departing from the spirit and scope of the invention. Thus, the following detailed description is presented for purposes of illustration only, and not of limitation, and the scope of the invention is defined solely by the appended claims. The particular implementations shown and described herein are illustrative of the invention and its best mode and are not intended to otherwise limit the scope of the present invention in any way.

That said, the present invention generally provides systems and methods for motivating or encouraging users to reduce production of pollutants. In some embodiments, the system may be used to encourage alteration of other behaviors, such as to encourage users to stop smoking, lose weight, perform community service, and/or the like. It will be understood that the present system and method may be used to encourage alteration of any desired behavior.

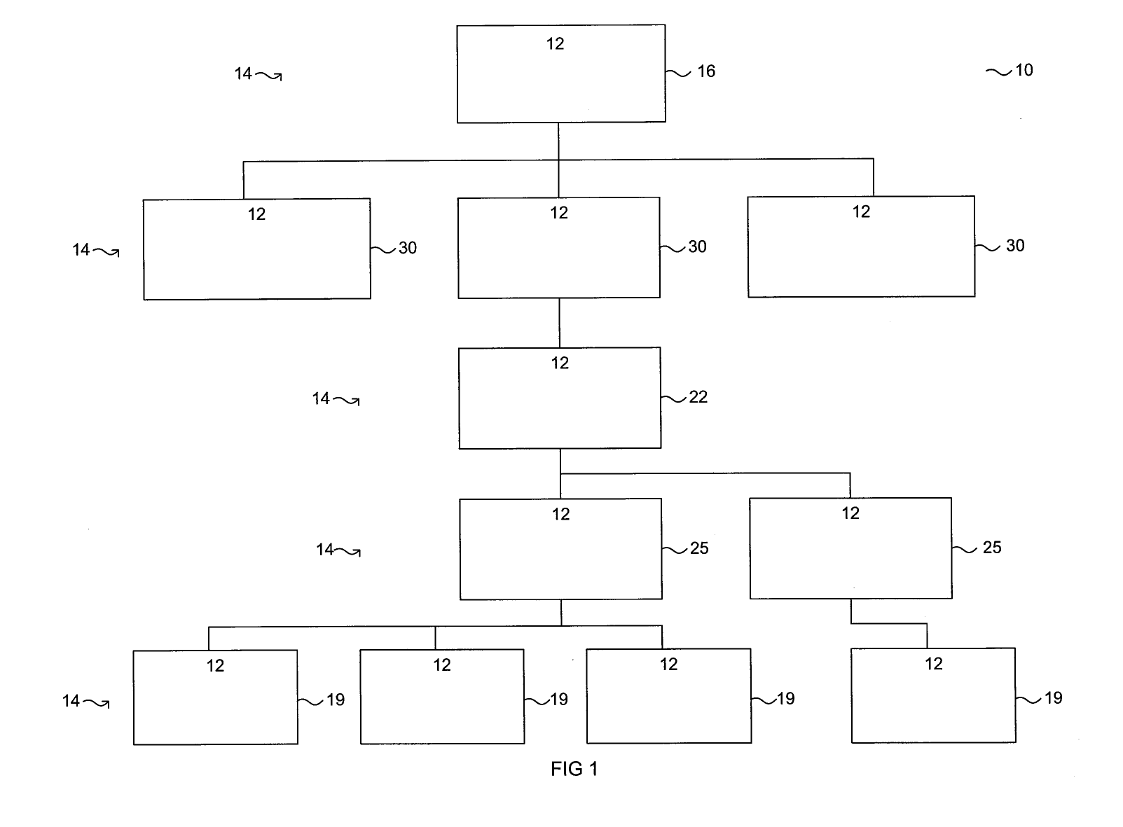

In an embodiment, a system of the present invention comprises a network of users having a common goal of reducing production of pollutants. FIG. 1 provides an example of a network 10 of the present invention. As illustrated, network 10 includes a plurality of users 12 organized in generations 14.

A user's relationship to other users in the network may be established or determined in any number of manners. In an embodiment, a first user may initiate the network, and may invite one or more additional users to connect to the network. Additional users may in turn invite one or more users to join, and so on.

In an embodiment, a user may invite another user to join their downstream network. For purposes herein, “downstream” means users of a later generation, and “upstream” means users of an earlier generation. For example, with reference to FIG. 1, first generation user 16 may invite second generation user 30 to join network 10 downstream.

In another embodiment, user 12 may be able to select an upstream user at the time of becoming a user of the system. Additionally or alternatively, the individual users 12 may be allowed to change their upstream or downstream connection at any time.

In an embodiment, the individual users may be allowed to select the users to which it is connected only by changing the immediate upstream user. With reference to FIG. 1 for example, fifth generation users 19 may be able to switch their own connections between fourth generation users 25, or may be able to connect directly or immediately to a first generation user 16, a second generation user 30, etc. Continuing with this example, should fifth generation user 19 change its connection away from fourth generation user 25 and connect directly to second generation user 30, the fifth generation user 19 would become a third generation user 22.

FIG. 1 illustrates network 10 comprising eleven users 12 and five generations 14. However, it will be understood that a network of the present invention system may comprise any desired number of users, generations, chains and side chains, and fall within the scope of the present invention.

In one embodiment, the network tracks the increase or decrease of consumption of an item by the users. Any desired item may be tracked using the present system and method. Examples of trackable items within the network include, but are not limited to, pollutants produced, cigarettes consumed, pounds of weight lost, hours of community service donated, etc.

The item may be tracked with the system for each user individually, overall for the entire network, and/or for any desired combination of users within the network. Moreover, items may be tracked in absolute terms, as a rate of consumption, or any other desired manner.

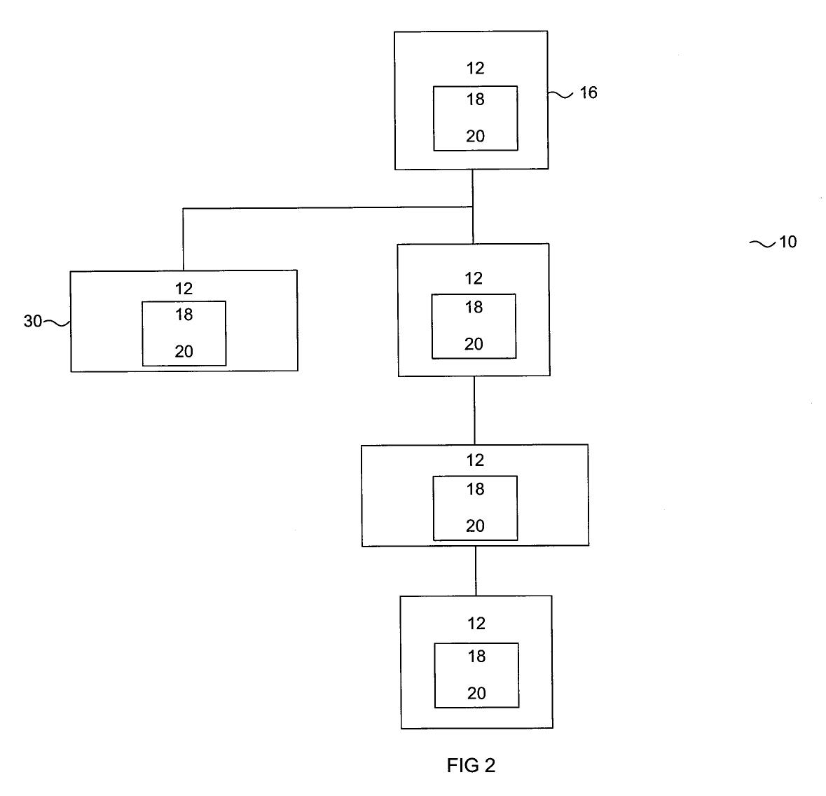

One implementation of the present systems and methods compares individual consumption savings of the users within the network. For example, FIG. 2 illustrates an embodiment of a network wherein individual savings 18 is tracked for each user 12 (although reference numeral 18 refers to individual savings for each user 12, it will be readily understood that the amount of individual savings 18 may be different for each user).

As mentioned above, the present invention motivates the users to change a particular behavior. The network may serve to alter behavior by providing one or motivators, such as recognition, reward, and/or competition.

In an embodiment, each of the users of the system is recognized for individual contributions and efforts to reducing consumption of the item, (i.e., the pollutants). For example, the first generation user 16 may be recognized for an individual savings 18 of an item. Similarly, second generation users 30 may each be recognized for their individual savings 18.

Accordingly, each of the users of the system is provided with recognition for individual efforts. Recognition may comprise any mechanism for acknowledging achievement of the users. Exemplary forms of providing such recognition may include periodic updates to a web page, periodic congratulatory emails, or other forms of informing at least the participating user of the individual contributions; other users of the system may also see displays or receive notifications regarding the contributions of others.

However, simply reminding an individual of what they have already done may not be sufficient motivation when the individual contributions are minimal compared to the scope of the overall problem being attacked. Accordingly, the present systems and methods may further provide individual users with feedback and/or recognition for the contributions and efforts of other users that are within the individual user's network.

As such, in an embodiment, a system may be configured to aggregate the amount of an item tracked for a group of users. For example, a user's savings may include (in addition to their own individual savings), the sum of the individual savings of all users downstream. Such aggregate amount is referred to herein as network savings. In this embodiment, upstream users may be credited with the aggregate savings of the item by downstream users. For example, referring again to FIG. 2, first generation user 16 may be credited with the individual savings 18 of all downstream users.

A user may also be provided with recognition for its network savings 20. Here again, the recognition may come to the attention of the first generation user 16 and/or other users through one or more of a variety of means.

In some implementations of the present systems and methods, the individual savings 18 of downstream users may be only partially credited to upstream users. The credited portion may be calculated according to a variety of methods, such as a diminishing portion for each successively distant tier or a consistent portion size for each successive tier. Additionally or alternatively, a user may elect to be directly and immediately downstream from two different upstream users (not shown), in which case the downstream user may allocate a portion of its individual and/or network savings to each of the upstream users to which it is directly and immediately connected.

At least some implementations of the present disclosure allow each upstream user's network savings 20 to be credited for the entire individual savings 18 of every downstream user. This can be seen with reference to the network savings 20 of the various users 12 at the various generational tiers 14. It will be understood that although reference numeral 20 refers to network savings for all users, it will be readily understood that the network savings may be different for each user. For example, the value of the network savings may depend on the number of downstream users.

It will be understood that network 10 is illustrated in FIGS. 1 and 2 in schematic form and the data and substance of network 10 may be presented to users in any manner so as to communicate the information schematically presented. The systems and methods of the present disclosure can be seen to place no limit on the total number of users, the number of first generation users, or the number of users at any particular level.

While some implementations of the present system and methods may institute rules governing the relationships between users, other implementations may provide mere guidelines, suggestions, or tips. One exemplary basis for limiting or suggesting the appropriate or acceptable connections between users is on the basis of influence. For example, in an embodiment, network 10 may be intended to show the global impact of first generation user 16 through the first generation user's own efforts to limit pollutant production and/or through the first generation user's efforts to encourage others to do the same. If some user wholly unconnected with the first generation user 16 decides to connect to the first generation user 16, the pollutant network 10 may not provide its intended representation.

In some embodiments, a user of the present system and methods may be connected to another user in a tenuous fashion such that effectively no limits are placed on the appropriate connections between users. One example of a fairly tenuous connection might include a random individual that first encounters the present system, on the internet as an example, and is inspired by the observation that a particular user managed to individually save a large number of units of pollutants. That inspiration alone may be enough to cause the random individual to join the present system and to connect itself directly to the user, even though the user did not affirmatively or intentionally do anything to contact or otherwise communicate with the new user.

With continued reference to FIG. 2, it can be seen that the present systems and methods both recognize and reward individual users for their efforts. The reward comes from the potential to continually increase each individual's network savings 20. The recognition comes from the various methods that may be used, such as web site updates, email ‘certificates,’ or other periodic forms of recognition, which may also provide a reward deriving from the satisfaction received from the recognition. The recognition of both individual savings 18 and network savings 20 provides multiple levels and degrees of recognition that may continue to inspire the individual to strive to decrease pollution production, either through their own conservation efforts or through encouraging conservation by others.

Additionally, the methods and systems of the present disclosure may provide motivation and encouragement to users through principles of competition. As seen in FIG. 2, the pollutant network 10 may be set up in the system so that all of the users can see the savings statistics of all of the other users. Many people possess an internal competitive spirit that responds to comparisons, particularly comparisons in which they believe they can improve their position relative to others. Accordingly, a user, such as the fourth generation user 28, may view the savings statistics of the other users and be motivated to strive to improve its statistics relative to others, such as by increasing individual conservation efforts or by encouraging still more people to conserve and join the network as a fifth generation user connected to the fourth generation user 28. Additionally or alternatively, the methods and systems of the present disclosure may intentionally create a spirit of competition between the users through challenges (such as short-term or long-term increases in conservation or drives to invite or recruit more users) and/or through periodic rewards, which may be based on any number of criteria.

Accordingly, the systems and methods of the present disclosure may motivate individuals to strive to reduce pollutant production through one or more of these motivational techniques discussed above. These same motivational techniques may be applied to encourage or motivate individuals to invite others to participate in the present systems and methods to further increase the reductions in pollutant production.

The system of the present invention may be operated in connection with any known or hereinafter developed platform. For example, in one embodiment, the system may be operated on an internet platform. In other embodiments, the system may be operated via mail or in person.

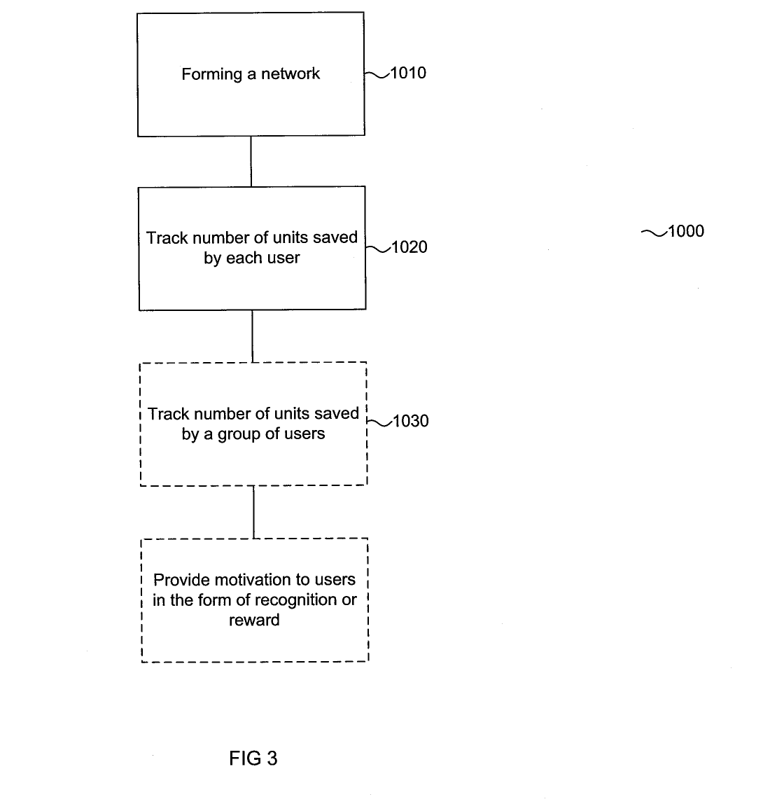

With reference to FIG. 3, a method 1000 in accordance with the present invention includes the steps of: forming a network of two or more users who share the common goal of conserving an item to the network (1010); tracking the number of units of the item saved by each of the users (1020). In some embodiments, the method may further include the steps of: tracking the number of units of the item saved by a group of users within the network (1030); and/or providing motivation to one or more users in the form of recognition and/or reward (1040).

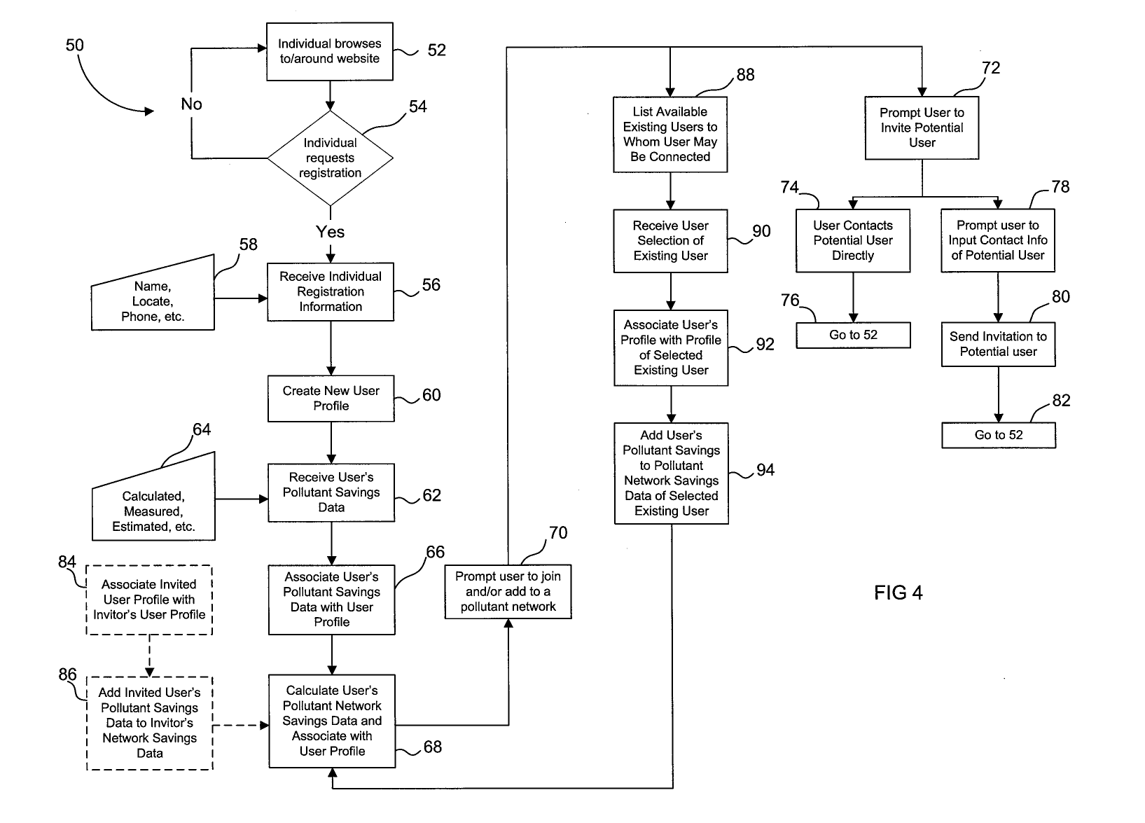

Turning now to FIGS. 4-12, exemplary implementations of the systems and methods of the present disclosure are provided. These Figures are representative of input screens associated with forming a network of the present invention. FIG. 4 presents a schematic block diagram 50 of various steps in implementing the present systems and methods to accomplish a desired reduction in pollutant production. As indicated above, the present systems and methods may be implemented in a number of formats, such as via postal mail and correspondence. Additionally or alternatively, the present systems and methods may be better suited for implementation in a networked computer environment, such as on the internet and/or via email. As the internet is a currently preferred implementation of the present systems and methods, the following discussion will refer to the systems and methods as a web-based community.

Potential users of the present systems and methods might encounter the web-based community through random internet browsing, through internet searching, through internet advertising links, through emails providing links to the web-based community, or through any of the other various methods through which internet users come across new websites. Regardless of the means used, the method illustrated in FIG. 4 begins with an individual browsing to and/or around the website hosting the web-based community, which is shown at 52. While at the website and browsing around the website, the individual and potential user may be able to participate in a number of activities. For example, the potential user may be able to learn about pollution and ways to reduce pollutant production. Similarly, the potential user may be able to learn about how much pollution they likely cause through normal everyday living (such as through the electricity and gasoline used) and may be able to find resources for finding more environmentally friendly living, such as environmentally friendly utility companies. Additionally, the potential user may be able to get involved, contact politicians or other influential people, or otherwise become an active participant in the effort to reduce pollutant production.

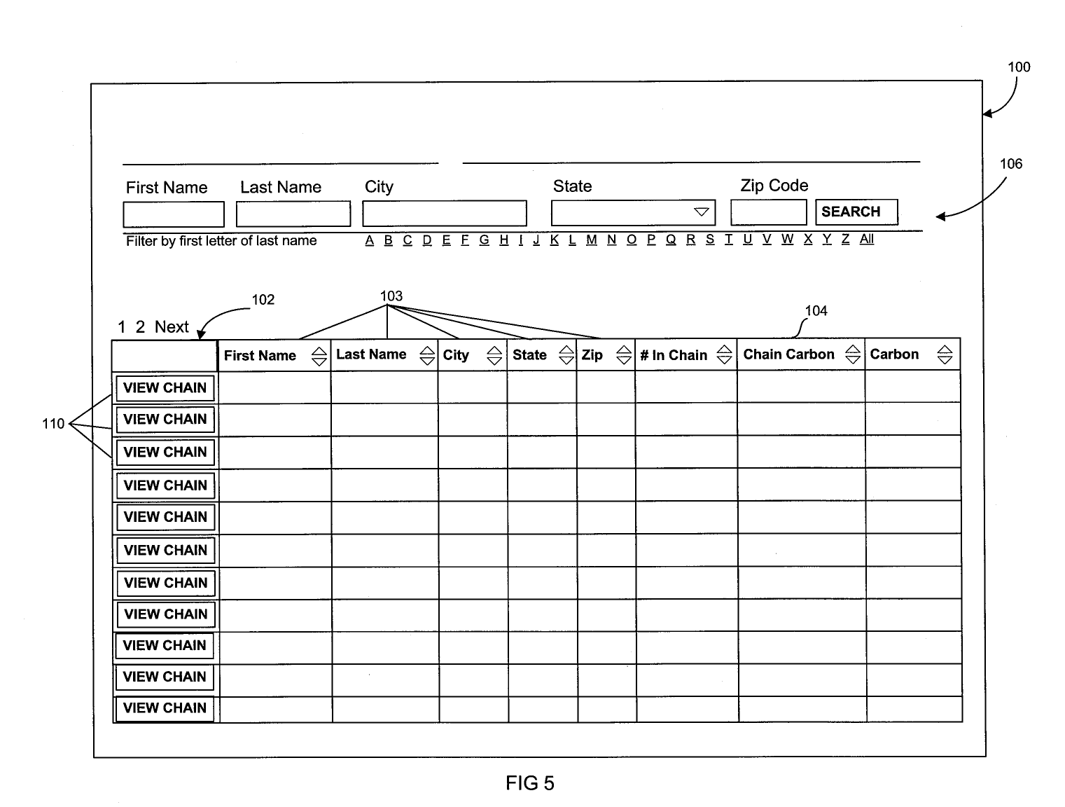

Potential users visiting the website may be able to view statistics regarding various aspects of the web-based community hosted on the website. For example, the potential user may be able to view the individual savings and network savings of one or more of the users and may be able to view the pollutant networks of the users. FIG. 5 presents a representative user statistics screen 100 of the website showing user and network statistics to potential (and/or current) users. As illustrated, FIG. 5 refers to the pollutant networks of the present disclosure as “chains” in the view networks column 102 or “carbon chains” in the network savings column 104. Biographical data columns 103 of the network chain users are also illustrated. More or less information about the existing users and their pollutant networks may be shown on this statistics screen. Users and potential users may also be able to search for particular users and/or apply filters to find particular users through search and/or filter features such as those shown at 106.

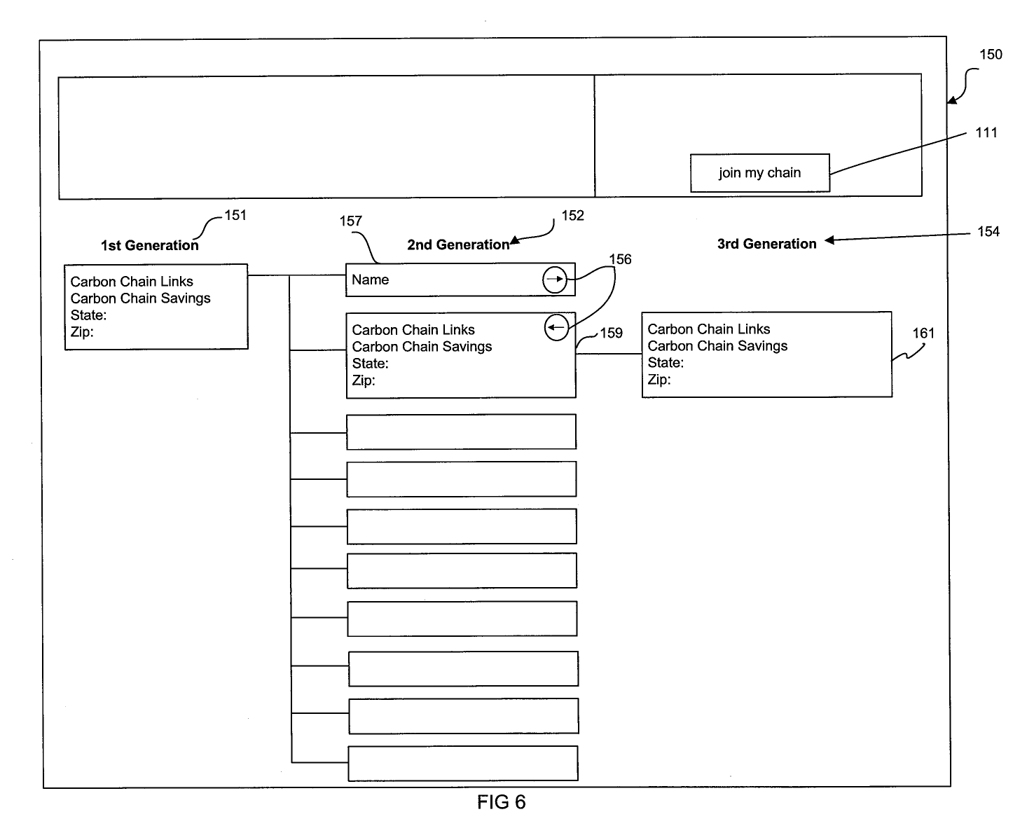

FIG. 6 illustrates an exemplary user profile view screen 150 presenting a graphical representation of a user's pollutant network and showing three generations of users 151, 152 and 154 that are linked to the user being displayed. Other methods of displaying or providing information regarding user's pollutant network may be implemented as well, including more or less information about the user and or the user's network.

In accordance with an embodiment, an individual browsing the website may be able to view varying levels of information regarding the web-based community. For example, to facilitate the presentation of multiple generations, one or more of the generations may be collapsible and expandable. An example of such functionality is shown in FIG. 6 illustrated in second generation 152 as collapsed form 157 (i.e., name only), and expanded form 159. The information displayed in the collapsed and expanded form may vary to suit the needs of the website administrator, the user whose information is being displayed, and/or the user or potential user that is viewing the user's pollutant network.

Additionally, considering the third generation 154 shown in FIG. 6, it can be seen that only one third generational descendent 161 is displayed. In some implementations, the descendants of more than one user may be shown in the third column. As illustrated, second generation users 152 are displayed including a generational expansion button 156. Generational expansion button 156 allows the viewer to select which second generation user's descendants are displayed. In the illustrated example of FIG. 6, clicking on generational expansion button 156 would collapse third generation user 161, producing a display with no users in the third generation 154.

Returning to FIG. 4, at some point while a potential user is browsing the website at 52, the potential user may request to become a registered user of the web-based community, shown at 54 in FIG. 2. The potential user may be prompted or asked to become a registered user in any number of manners on one or more of the screens available to an unregistered visitor. Generally, a potential user desiring to become a registered user initiates the registration process by clicking on a link. An exemplary link is shown in FIG. 6 as a “join my chain” link 111. Link 111 may be operable to allow the potential user to register with the web-community and become automatically connected to the user from whose profile the link was clicked. In the exemplary profile 150 shown in FIG. 6, a potential user may register with the community by clicking the link 100, thereby becoming a second generation user 152 of the pollutant network. In other embodiments, potential users may additionally or alternatively request registration with the web-based community by clicking more general links that are not associated with particular users.

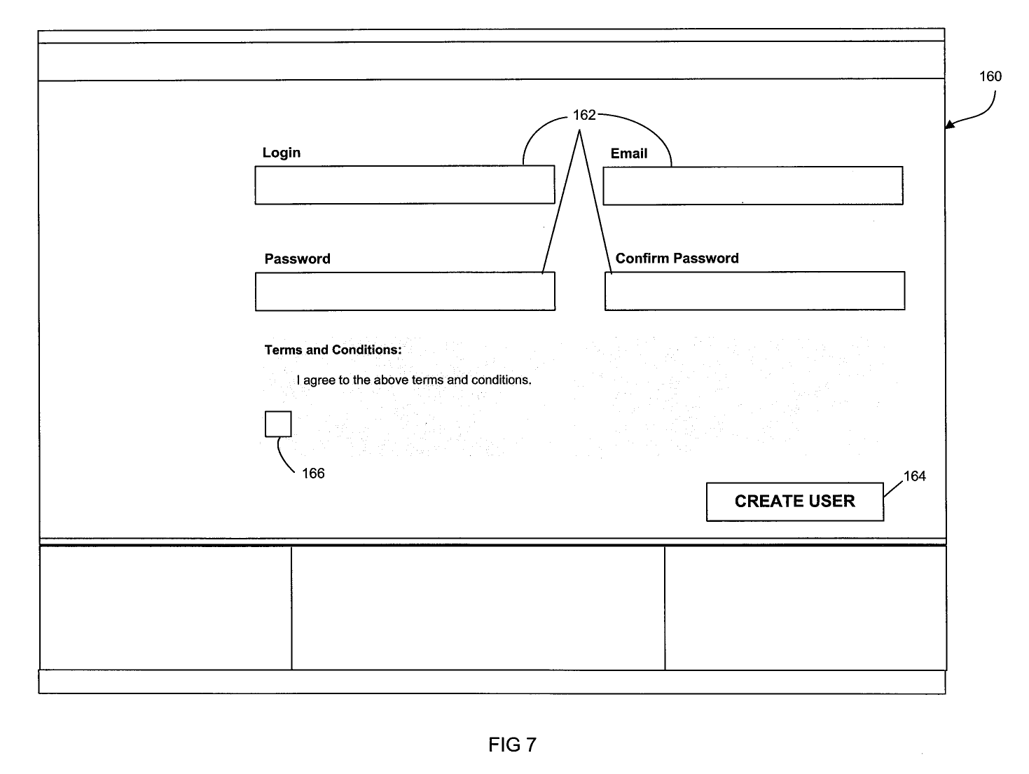

Once the potential user requests registration with the web-based community, the potential user may be directed to an account creation screen, such as the exemplary input screen 160 shown in FIG. 7. Account creation screen 160 may require one or more inputs 162 from the potential user. For example, a user may type information into inputs 162, such as user name, password, and e-mail address. Any number of inputs 162 may be present on input screen 160, depending upon the on the demands or interests of the network community administrator.

As one example of an alternative account creation screen, the community administrator may utilize the potential user's email address as the user name, thereby eliminating at least one input. After inputting the required information, the potential user may click the appropriate create user link 164 to create a user. In some implementations, the web-based community administrator may require a potential user to agree to certain terms or conditions, at 166, prior to creating a user.

Returning again to FIG. 4, the steps of implementing and developing the present web-based community may proceed by collecting additional information about the new user, such as shown at 56 in FIG. 4. The additional information may include the information 58 necessary to create a new user profile, at 60 in FIG. 4. Exemplary information 58 that may be requested and/or required may include the name, locale, photo, or other information about the individual that is becoming a user and member of the web-based community.

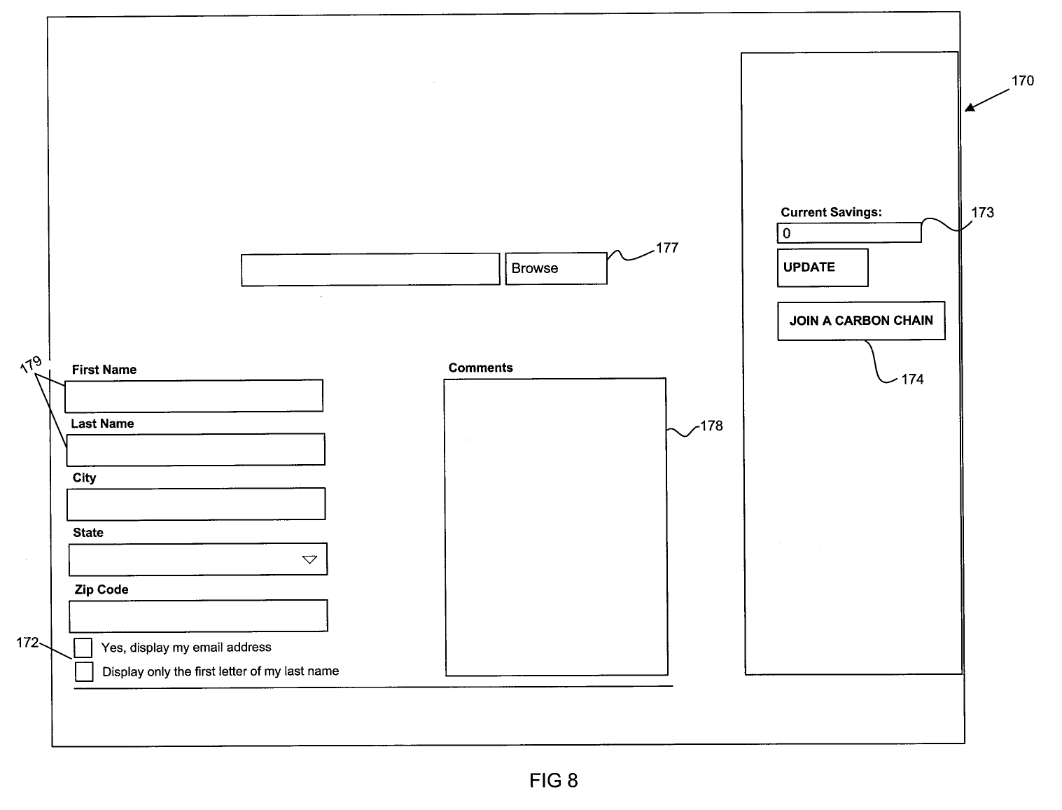

FIG. 8 illustrates an exemplary input screen that may be used to create and/or edit a user profile, which is shown as a user profile screen 170. The specific information requested to create the user profile may include more or less information than that presented in FIG. 8. Additionally, the user profile information may be requested on the same screen as the account creation screen to reduce the number of input screens seen by the user. Additionally or alternatively, the web-based community administrator may provide the user profile screen 170 with a variety of configuration options to allow the user to modify one or more aspects of the user's interaction with the web-based community. One example of such an option is shown as questions 172 asking the user how much information to display to others in the community.

FIG. 8 further illustrates that in some implementations of the web-based community, the user may be able to input and/or update the individual user's pollutant savings 173, which was discussed as the individual savings 18 in connection with FIG. 1. As illustrated schematically in FIG. 4, the present system may receive a user's pollutant savings data, at 62, from a variety of carbon savings sources 64. With continuing reference to FIG. 8, the user-interface with the present web-based community may present the pollutant savings input question in a variety of manners depending on the complexity of the web-based community. For example, when the community is set up to assist the user in calculating pollutant savings, the user profile screen 170 may include a link to a calculation screen and/or may include calculation tools (not shown) on the profile screen 170. In a simple implementation, the user may simply input an amount that they believe to estimate the amount of pollutant they are saving from their efforts. As shown, the user profile screen 170 may further include a link to upload photo 177, inputs 179 to upload additional biographical information, and an input block 178 for comments.

A variety of methods may be used to calculate, or to help a user estimate, the amount of pollutants being saved by a user's conservation efforts. Exemplary questions that might be used to help calculate a person's pollutant production and savings include any of: how much electricity, natural gas, heating oil, etc. is consumed or used each month, how many miles are driven, what type of car is driven, how much gasoline is used in the cars each month, how much is spent on utilities such as electricity, gas, etc., how much of the electricity comes from green sources, etc. In some implementations, the web-based community may calculate/estimate an average monthly savings and add to the individual's “lifetime” individual savings each month. Additionally or alternatively, the community may be implemented to modify the individual savings each month according to seasonal averages or some other factors to more accurately reflect the user's actual pollutant savings.

In other embodiments, a web-based community according to the present disclosure may be tied to a user's utility provider and/or a bill pay service to automatically receive information regarding the user's utility consumption each month. In some implementations of the present disclosure, the web-based community may be implemented as part of a utility provider's own website to better serve their consumers. In such implementations, the communication between the web-based community and the utility provider may be facilitated and the data regarding pollutant savings may be more accurately updated each month. As one exemplary implementation by a utility company, the utility company may provide the features and services described herein to registered users of the utility company's website, particularly where the utility company is a provider of both conventional and green utility options. As more utility companies are becoming environmentally conscious and attempting to encourage consumers to use green alternatives, such implementations may be advantageous to the utility company.

Regardless of how the user's pollutant savings data is calculated or estimated and input into the web-based community, the user's pollutant savings data is associated with the user's profile, as shown at 66 in FIG. 4, becoming the user's individual savings 18. Continuing with FIG. 2, the user's pollutant network savings data is then calculated and associated with the user's profile, at 68, becoming the user's network savings 20.

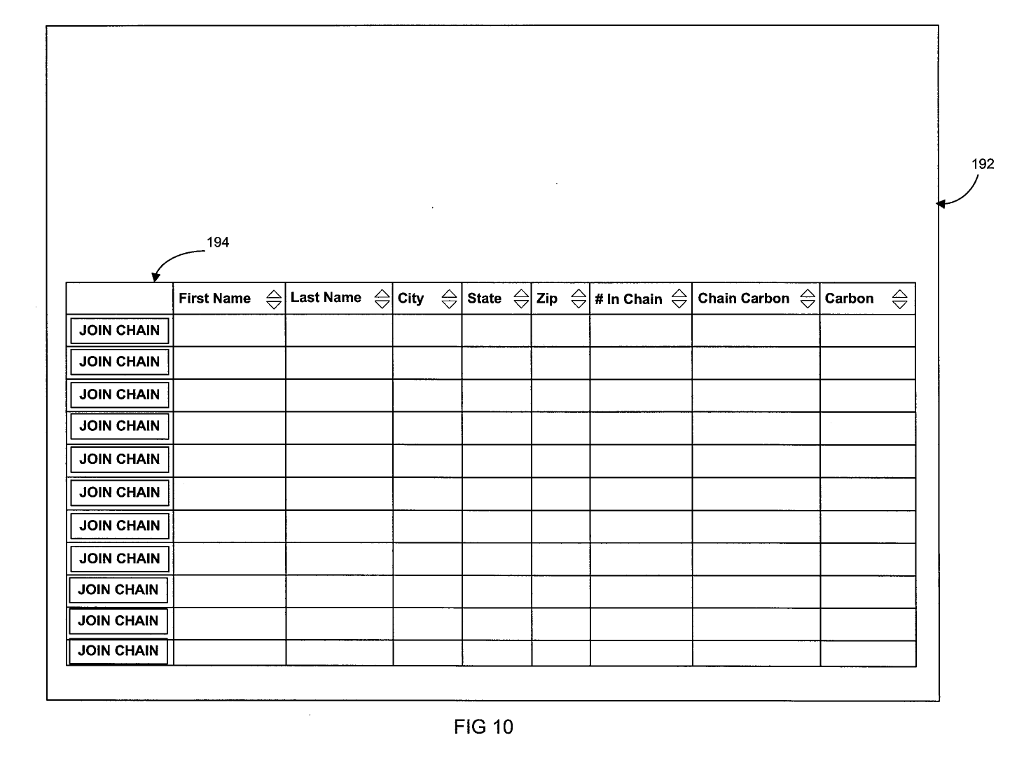

With continuing reference to FIG. 4, the user may then be prompted to join another user's pollutant network and/or may be prompted to invite others to join the user's own pollutant network, as indicated at 70 in FIG. 4. FIG. 10 illustrates exemplary methods of prompting the user for one or both of these purposes. For example, the user profile screen 170 may include a join link 174, which, when clicked, allows the user to join another user's pollutant network, as will be described in more detail below. Additionally, the user profile screen may include an invite link, which, when clicked, allows the user to invite others to learn about and join the web-based community. The links and layouts of FIG. 10 are representative only as many different formats and tools may be used to prompt a user to invite others and/or to join a particular user's network. For example, a pop-up display may appear at predetermined, random, and/or periodic times to remind the user that the user can invite others to join the community and/or that the user can join another user's pollutant network. In implementations of the present disclosure that are not web-based, paper mailers may be sent to the registered user from time to time to prompt them to invite others to participate in the community.

Regardless of the manner through which the registered users are prompted or reminded that the users can invite others to the community, the next step may be to prompt the user to invite potential users, as illustrated at 72 in FIG. 4. While a registered user may be able to invite virtually anyone to join the community, such as by uploading the contacts from a personal information manager, the administrator of the web-based community may prefer to prompt the registered user to invite those that the registered user would consider to be potential users. By allowing registered users to invite new users, such as individuals believed to be potential users, the present web-based community implements principles of viral marketing to grow the population of the web based community. As the individual user's pollutant networks grows, the user's network savings will continue to increase so that the users will see the benefits of their total impact (including the efforts of others in the network) on the environment rather than merely the limited scope of their personal efforts. In addition to the altruistic benefit and reward of seeing the pollutant products reduced, one or more of the motivational principles discussed above may encourage users to invite friends, family, and others to join the web-based community. By allowing, and even encouraging and rewarding users for promoting the web-based community to friends, the viral marketing allows the web-based community to grow at low cost to the community administrator.

Returning to the schematic representation of FIG. 4, once the user has determined to invite others to the community, the community administrator may facilitate that invitation in a number of ways. As one example, the administrator may provide sample invitation texts and or links that the user can copy and paste into an email sent from the user's computer, either via a web-based email application or client or through the user's own standalone email application. As illustrated in FIG. 4, this approach is presented at 74 where the user is allowed to contact potential users directly. The invited user would then potentially visit the website hosting the web-based community and then participate in the systems and methods described herein, at 76.

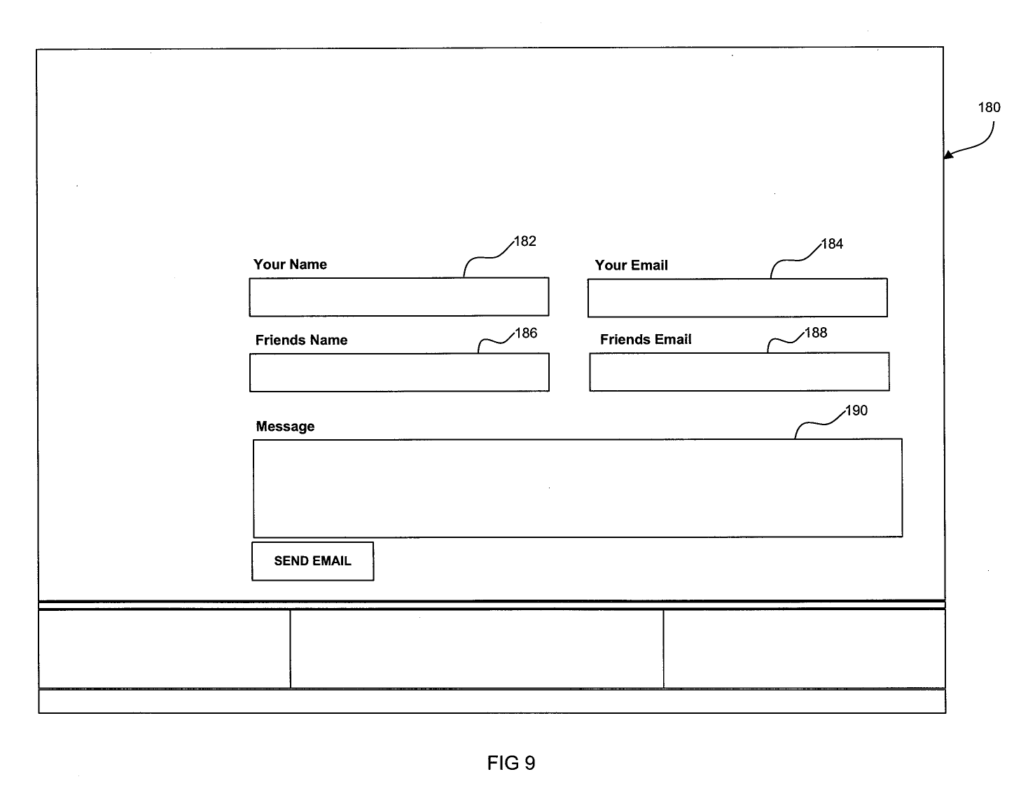

Additionally or alternatively, the web-based community administrator may allow the user to input contact information of one or more potential users directly into the web-based community via one or more suitable forms and/or input screens. In FIG. 4, the step of prompting a user to input potential user contact information is shown at 78. FIG. 9 illustrates a representative potential user information input screen 180. As illustrated in FIG. 9, the user may be prompted to input very basic contact information about the user, such as name 182 and email address 184, and the potential user, such as name 186 and email address 188, along with a personal message 190 to be delivered to the potential user. The information from the potential user information input screen 180 may be used to automatically generate an email message to the potential user. Additionally or alternatively, the present systems and methods encompass web-based communities implementing any of the various systems and methods that are currently being used to facilitate viral marketing and/or sharing of websites. When the registered user inputs potential user information into the web-based community, the present systems and methods then send an invitation to the potential user, as indicated at 80 in FIG. 4.

As discussed elsewhere herein, the present disclosure encompasses systems and methods that are not implemented on the internet. For example, conventional mail-based implementations are possible. In a mail-based implementation, the user may receive previously prepared invitations that can be sent to potential users and/or may receive a potential user information form that can be returned to the community administrator so that the community administrator can contact the potential user. Other variations to accommodate a non-internet based implementation are possible and within the scope of the present disclosure.

Once the potential user receives an invitation, whether from an existing user directly or from the community administrator, the potential user may then visit the website hosting the web-based community, as illustrated at 82 in FIG. 4. Accordingly, the invited potential user will be able to experience the various aspects of the web-based community described herein, including forming new pollutant networks, joining existing networks, and inviting others to participate in the web-based community.

In some implementations of the present systems and methods, the invitation sent the potential users may include a link for the invited user to be directed to a website hosting the web-based community. Additionally, the invitation may include a link that allows the invited user to be directed to the web-based community and to be joined to the inviting user's profile. For example, the invited user may be allowed to browse the website to learn about the community and, upon requesting registration and proceeding through the registration process, the invited user's profile may be associated with inviting user's profile, such as shown at 84 as an optional step in the present systems and methods. As described above, once two user's profiles are associated, the descendent user's, such as the invited user in this example, pollutant savings are added to the inviting user's, or upstream user's, network savings data for the purpose of calculating the inviting user's network savings, such as schematically shown at 86 in FIG. 4. The automatic linking of the invited user profile to the inviting user's profile is optional in the implementation of the web-based community and may be accomplished through a variety of methods, such as temporary cookies, session tracking, or other such techniques. Additionally, the automatic linking of the invited user's profile to the inviting user's profile may be undone by the invited user by editing the invited user's profile. Accordingly, the invited user, just as any other user of the web-based community, may be able to customize the invited user's direct relationship to others in the community, such as to become a first generation user or to be a second, third, fourth, etc. generation user under another user.

As discussed briefly above, a user may be prompted to join an existing pollutant network by creating an upstream linkage to one or more existing users. Once a user indicates a desire to be linked upstream to an existing user, the present systems and methods may provide a listing of the users in web-based community, at 88 in FIG. 4. FIG. 10 presents an exemplary representation of a join network selection screen 192 that may be used to facilitate the user's selection of a network to which the user can be upstream linked. A comparison of FIG. 10 and FIG. 5 illustrates that the join network selection screen 192 and the user statistics screen 100 may present much of the same information and functionality, such as search, filter, and sort functionality. Additionally or alternatively, the join network screen 192 and the user statistic screen 100 may present different information depending on the configuration of the web-based community. As presented in FIGS. 10 and 5, the primary difference between the user statistics screen 100 and the join network selection screen 192 is the text and functionality of the link in the view networks column 102 is changed in the join networks column 194 to reflect that the link in the join networks column 194 will associate the user's profile with the selected existing user should the link be clicked. With continuing reference to FIG. 4, the systems and methods of the present disclosure proceed from listing available users at 88 to receiving a user's selection of existing users at 90 and associating the user's profile with the profile of the selected user to create the upstream linkage at 92. The pollutant savings data of the user creating the upstream linkage is then added to the upstream user's network savings data at 94. The affected user's profiles are then updated with calculated pollutant network savings data, which is associated with the users' respective profiles, at 68.

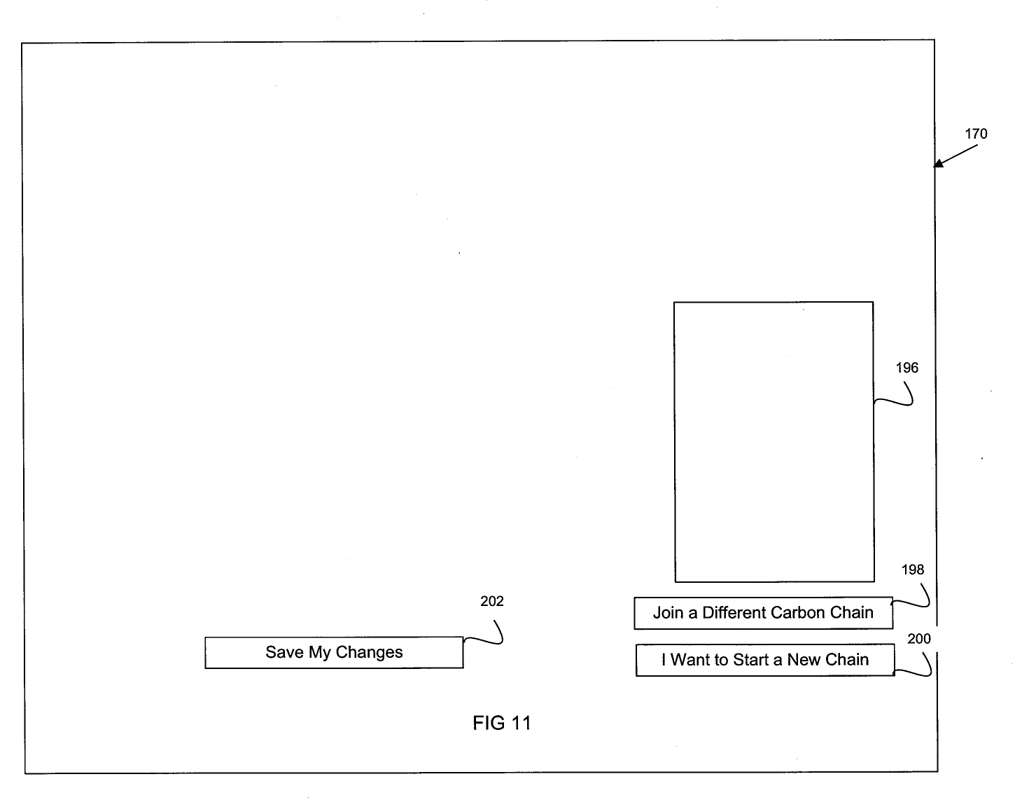

Continuing with the discussion of a user that wants to add or modify the user's upstream linkage within the community, once the user selects an existing user to which the user would like to be linked, such as by clicking on a link in the join networks column 194, the user may be redirected back to the user profile screen 170 which was previously discussed in connection with FIG. 6. FIG. 9 shows another view of an exemplary user profile screen 170, with this viewing illustrating one possible layout for a user profile that has an established upstream connection within the network. The user's upstream connection is illustrated at 196 in FIG. 9. Additionally, as shown in FIG. 11, the user profile screen 170 may include links to allow a currently linked user to further modify the user's upstream linkage. Exemplary links include a join a different network link 198 and a start a new network link 200.

FIG. 11 illustrates a user profile screen 170 in an edit or update mode wherein the user can customize and change the user profile in a number of ways. At any time during the editing of user profile screen 170, the user may elect to save the profile, such as by clicking a save a profile link 202. Upon clicking the save profile link 202, the user may be directed to a user profile view screen, such as the representative user profile view screen 210 shown in FIG. 10. While the user profile view screen 210 is comparable to user profile view screen 150 shown in FIG. 4, other user profile view screens may be implemented. Comparing FIG. 4 and FIG. 10 illustrates that the user profile of a user that is not a first generation user may illustrate the generational position of the user on the user profile view screen. Additionally, FIG. 10 illustrates that a registered user that is logged-in to the web-based community and viewing the user's own user profile may be presented with an edit profile link 212 rather than the join network link 110 seen in FIG. 4.

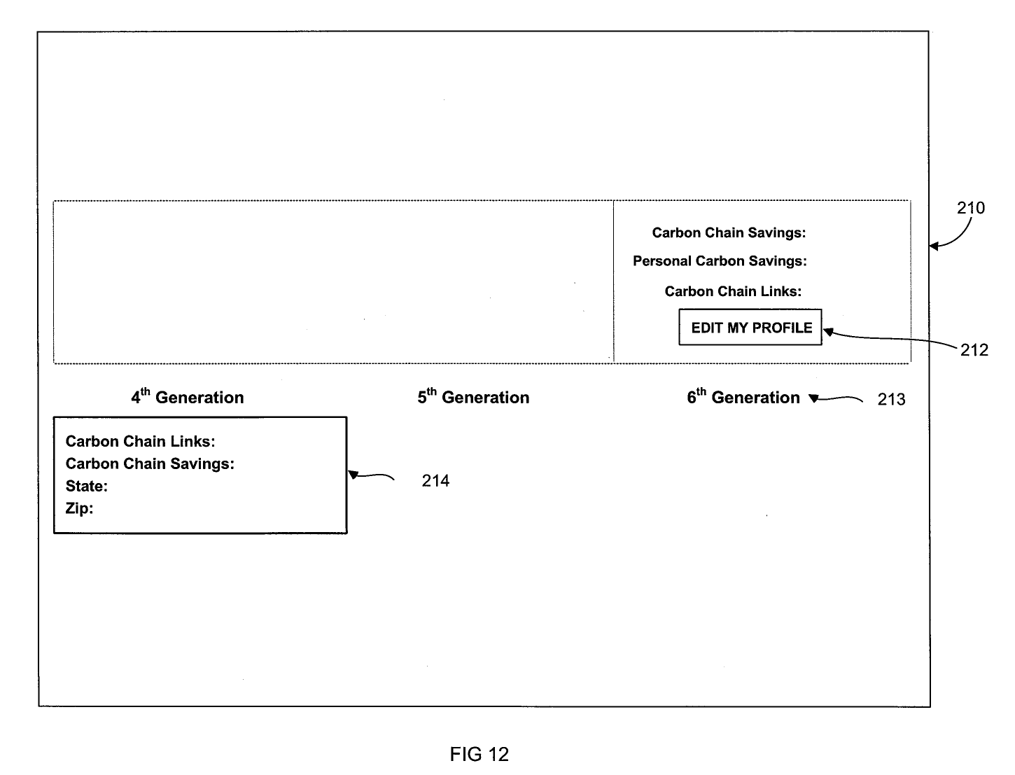

FIG. 12 illustrates user profile screen 210, which comprises an edit my profile link 212, displays the user's generational links 213, and the carbon savings 214 for the user.

In view of the foregoing discussion of FIGS. 1 and 2, the present disclosure encompasses systems and methods that enable an operator or administrator of such systems to encourage others to engage in conduct that will reduce the production of greenhouse gases and other pollutants. The present disclosure provides a method of recognizing and rewarding users for the user's own conservation efforts and a method of recognizing and rewarding users for the efforts of others that have been influenced by the user to engage in conservation efforts. Accordingly, through the present systems and methods, users may be motivated to engage in and/or to continue activities that will reduce the production of greenhouse gases and other pollutants. Moreover, the present disclosure may provide users with an easy method of inviting and encouraging others to participate in the communities of the present disclosure, thereby further encouraging the reduced production of greenhouse gases. With the available additional motivators of inherent and/or manufactured competition, the present systems and methods may further encourage reductions in the production of greenhouse gases. While the bulk of the foregoing discussion has considered web-based communities incorporating the principles of the present systems and methods, the present disclosure encompasses other implementations of these principles. As discussed previously, various aspects of the present disclosure can be modified or adapted to allow the one or more aspects of the communication between users to occur in a non-Internet based environment, such as via mail, email, or simply localized users groups.

It is believed that the disclosure set forth above encompasses multiple distinct inventions with independent utility. While each of these inventions has been disclosed in its preferred form, the specific embodiments thereof as disclosed and illustrated herein are not to be considered in a limiting sense as numerous variations are possible. The subject matter of the inventions includes all novel and non-obvious combinations and subcombinations of the various elements, features, functions and/or properties disclosed herein.

Benefits, other advantages, and solutions to problems have been described herein with regard to specific embodiments. However, the benefits, advantages, solutions to problems, and any elements that may cause any benefit, advantage, or solution to occur or become more pronounced are not to be construed as critical, required, or essential features or elements of the invention. The scope of the invention is accordingly to be limited by nothing other than the appended claims. All structural and functional equivalents to the elements of the above-described exemplary embodiments that are known to those of ordinary skill in the art are expressly incorporated herein by reference and are intended to be encompassed by the present claims.

I claim:

1. A system for monitoring consumption of an item comprising:
a network of users having a common goal of reducing consumption of an item, the users organized into a plurality of chains, each of the chains having a hierarchy of generations, wherein the users within a chain are located upstream or downstream relative to the other users within the chain, and the network tracks the individual savings of the item for each of the users.

2. A system according to claim 1, wherein the network tracks the network savings of the item for each of the users.

3. A system according to claim 2, wherein the network savings for each of the users within a chain is calculated as the sum of the individual savings of the user and the individual savings of all downstream users relative to the user.

4. A system of claim 1, wherein the item is a pollutant.

5. A system of claim 1, wherein the system provides at least one of feedback and recognition to the users.

6. A system of claim 1, wherein the network partially credits the upstream user with the individual savings of the downstream user.

7. A network system for tracking savings of pollutant gas production:
a network comprising a plurality of users, the network configured to track the individual savings and network savings of an item for each of the plurality of users,
wherein the network savings for each of the users is calculated as the sum of the individual savings of the item for each user and the individual savings of each of the downstream users.

8. A network system according to claim 7, wherein the upstream user is credited with the aggregate savings of the item by all downstream users.

9. A network system according to claim 7, the network comprising rules governing the relationship between the users.

10. A network system according to claim 7, wherein the system is operated on an internet platform.

11. A network system according to claim 7, wherein the plurality of users are organized into chains.

12. A network system according to claim 11, wherein the plurality of users are organized into generations within the chains.

13. A method for encouraging the reduction of pollutant gases comprising:
forming a network of two or more users;
tracking the number of units of an item saved by each of the users;
providing recognition to at least one of the users.

14. The method according to claim 13, further comprising the step of:
tracking the number of items saved by a group of the users within the network.

15. The method according to claim 13, further comprising the step of:
providing motivation to at least one of the users in the form of one of a reward.

16. A method according to claim 13, wherein the network is a web-based community.

17. A method according to claim 13, further comprising the step of organizing the users into chains.

18. A method according to claim 17, further comprising the step of organizing the users into generations within the chains.

19. A method according to claim 18, wherein the item is a pollutant.

20. A method of motivating individuals to reduce production of pollutants comprising the steps of:
forming a network comprising at least one user;
receiving a request for registration from a new user;
creating a new user profile for the new user;
receiving the new user's pollutant savings data;
associating the pollutant savings data with the user profile;
calculating the new user's network savings data;
associating the pollutant network savings data with the user profile;
prompting the new user to join a pollutant network;
listing existing users to whom the new user may be connected;
receiving the user selection of an existing user;
associating the new user profile with the profile of the existing user; and
adding the new user pollutant savings to the pollutant network saving of the existing user.
